(19) United States
(12) Patent Application Publication
(10) Pub. No.: US 2007/0057637 A1
(43) Pub. Date: Mar. 15, 2007

(54) Plasma display panel and method for forming electrode thereof

(76) Inventors: Dae Hyun Park, Yongin-si (KR); Kyung Ku Kim, Anyang-si (KR); Byung Hwa Seo, Seoul (KR); Min Soo Park, Seoul (KR); Won Seok Jeon, Suwon-si (KR); Dong Oh Shin, Gwecheon-si (KR); Deok Hai Park, Joong-gu (KR); Hong Cheol Lee, Seoul (KR); Je Seok Kim, Anyang-si (KR); Byung Gil Ryu, Seoul (KR)

Correspondence Address: FLESHNER & KIM, LLP, P.O. BOX 221200, CHANTILLY, VA, 20153, US

(21) Appl. No.: 11/518,498

(22) Filed: Sep. 11, 2006

(30) Foreign Application Priority Data
Sep. 12, 2005 (KR) 10-2005-0086788
Sep. 12, 2005 (KR) 10-2005-0084789
Sep. 13, 2005 (KR) 10-2005-0085095

(51) Int. Cl. H01J 17/49; B23P 19/00

(52) U.S. Cl. 313/583; 313/582; 29/746

(57) ABSTRACT

A method for manufacturing a plasma display panel is disclosed. In the plasma display panel including upper and lower panels bonded to face each other with barrier ribs therebetween, at least one of electrodes formed on the upper and lower panels has a ratio of width to thickness in a range of 5:1˜50:1.

This application claims the benefit of the Korean Patent Application Nos. P 2005-0084788 filed on Sep. 12, 2005, P 2005-0084789 filed on Sep. 12, 2005, P 2005-0085095 filed on Sep. 13, 2005, which is hereby incorporated by reference as if fully set forth herein.

### BACKGROUND OF THE INVENTION

1. Field of the Invention

The present invention relates to a plasma display panel, and more particularly, to an electrode structure of a plasma display panel and a method for forming the same.

2. Discussion of the Related Art

Generally, a plasma display panel includes upper and lower panels and barrier ribs formed between the upper and lower panels, and the barrier ribs serve to divide electric discharge cells from one another. Each discharge cell is filled with a primary electric discharge gas, such as neon, helium, mixed gas of neon and helium, or the like, and an inert gas containing a small amount of xenon. If an electric discharge occurs by a high-frequency voltage, the inert gas generates vacuum ultraviolet rays to excite phosphors between the barrier ribs, thereby realizing the formation of an image using light emitted from the phosphors. The plasma display panel having the above described configuration is thin and light, and therefore, is highlighted as a next generation display device.

FIG. 1 is a perspective view schematically illustrating the configuration of a plasma display panel. As shown in FIG. 1, the plasma display panel includes an upper panel 100 and a lower panel 110, which are coupled parallel to each other with a predetermined distance therebetween. The upper panel 100 of the plasma display panel includes a plurality of sustain electrode pairs in which scan electrodes 102 and sustain electrodes 103 are formed in pairs. The plurality of sustain electrode pairs are arranged on an upper glass plate 101 serving as a display surface on which images are displayed. The lower panel 110 of the plasma display panel includes a plurality of address electrodes 113 arranged on a lower glass plate 111 to cross the plurality of sustain electrode pairs.

Barrier ribs 112 are arranged parallel to one another on the lower panel 110. The barrier ribs have a stripe form (or well form) for forming a plurality of discharge spaces, i.e. discharge cells. The plurality of address electrodes 113 are disposed parallel to the barrier ribs 112 and adapted to generate vacuum ultraviolet rays via implementation of an address discharge. R, G and B phosphors 114 are applied onto a top surface of the lower panel 110 and adapted to emit visible rays for displaying images during the address discharge. Also, a lower dielectric layer 115 for protecting the address electrodes 113 is formed between the address electrodes 113 and the phosphors 114.

The conventional plasma display panel having the above described configuration is basically manufactured through a glass manufacturing process, upper panel manufacturing process, lower panel manufacturing process, and assembling process. Also, a method for forming the electrodes of the plasma display panel is selected from among a screen printing method, photosensitive paste method, photo-etching method by sputtering, green sheet method, and the like.

However, the screen printing method has a difficulty in alignment because a printing process has to be repeatedly performed and also, cannot achieve high definition due to fluidity of a printing paste. The green sheet method is suitable to achieve a high definition electrode, but suffers from very high costs.

The photo-etching method by sputtering exhibits a complicated process and thus, is not preferable despite an advantage of high definition. Also, the photosensitive paste method has a problem in that electrodes may be peeled off unintentionally upon release of a photosensitive film pattern, or the photosensitive film pattern may fail to be released if an electrode paste remains on the photosensitive film pattern.

### SUMMARY OF THE INVENTION

Accordingly, the present invention is directed to a plasma display panel and method for forming electrodes thereof that substantially obviate one or more problems due to limitations and disadvantages of the related art.

An object of the present invention is to manufacture an electrode pattern of a plasma display panel by an ink-jet process or offset process without causing the lifting of opposite ends of the electrode.

Another object of the present invention is to achieve conformity in an electrode pattern of a plasma display panel by an offset process.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, in a plasma display panel comprising upper and lower panels bonded to face each other with barrier ribs therebetween, at least one of electrodes formed on the upper and lower panels has a ratio of width to thickness in a range of 5:1˜50:1.

In accordance with a further aspect of the present invention, there is provided a method for forming electrodes of a plasma display panel comprising: preparing a master mold that is formed with recesses having a ratio of width to thickness in a range of 5:1˜50:1; injecting an electrode paste into the recesses formed in the master mold; transferring the electrode paste injected in the recesses onto a blanket; and transcribing the electrode paste, transferred to the blanket, onto a substrate.

In accordance with still further aspect of the present invention, there is provided a method for forming electrodes of a plasma display panel comprising: transmitting a signal for controlling an injection position and injection amount of ink from a controller; and regulating the position and amount of ink to be injected from nozzles based on the control signal, to form electrodes having a ratio of width to thickness in a range of 5:1˜50:1.

In accordance with another aspect of the present invention, there is provided a plasma display panel comprising upper and lower panels bonded to face each other with barrier ribs therebetween, wherein the upper panel is formed with sustain electrode pairs each including transparent electrodes, a black electrode and a bus electrode, and wherein, in a pad portion of the panel, a width of the black electrode is greater than a width of the bus electrode.

In accordance with still a further aspect of the present invention, there is provided a method for forming electrodes of a plasma display panel comprising: forming black electrodes via an offset process using a first master mold: and forming bus electrodes via an offset process using a second master mold.

In accordance with another aspect of the present invention, there is provided a plasma display panel comprising upper and lower panels bonded to face each other with barrier ribs therebetween, wherein an electrode line of a connecting portion that connects an effective display portion and a pad portion is curved.

In accordance with yet another aspect of the present invention, there is provided a method for forming electrodes of a plasma display panel by an offset process comprising: transferring an electrode paste onto a blanket: and transcribing the electrode paste, transferred on the blanket, to a substrate, to form a curved electrode line in a connecting portion of the panel.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a perspective view illustrating an embodiment of a plasma display panel;

FIG. 2 is a schematic view illustrating an electrode of a plasma display panel according to a first embodiment of the present invention;

FIG. 3 is a view illustrating the lifting of an electrode formed by an ink-jet process or off-set process;

FIG. 4 is a sectional view illustrating the electrode of the plasma display panel according to the first embodiment of the present invention;

FIGS. 5 and 6 are schematic views illustrating a first embodiment of a method for forming the electrodes of the plasma display panel according to the present invention;

FIG. 7 is a schematic view illustrating a second embodiment of the method for forming the electrodes of the plasma display panel according to the present invention;

FIG. 8 is a plan view illustrating the electrode of the plasma display panel according to the second embodiment of the present invention;

FIGS. 9 to 12 are sectional views illustrating the electrode of the plasma display panel according to the second embodiment of the present invention;

FIG. 13 is a view illustrating an electrode pattern of a plasma display panel formed by a conventional electrode forming method;

FIG. 14 is a view illustrating an electrode pattern of a plasma display panel formed by an electrode forming method according to a third embodiment of the present invention;

FIG. 15 is a schematic view of the electrode pattern of the plasma display panel according to the third embodiment of the present invention; and

FIG. 16 is a view comparing the electrode pattern of the plasma display panel according to the third embodiment of the present invention with the prior art.

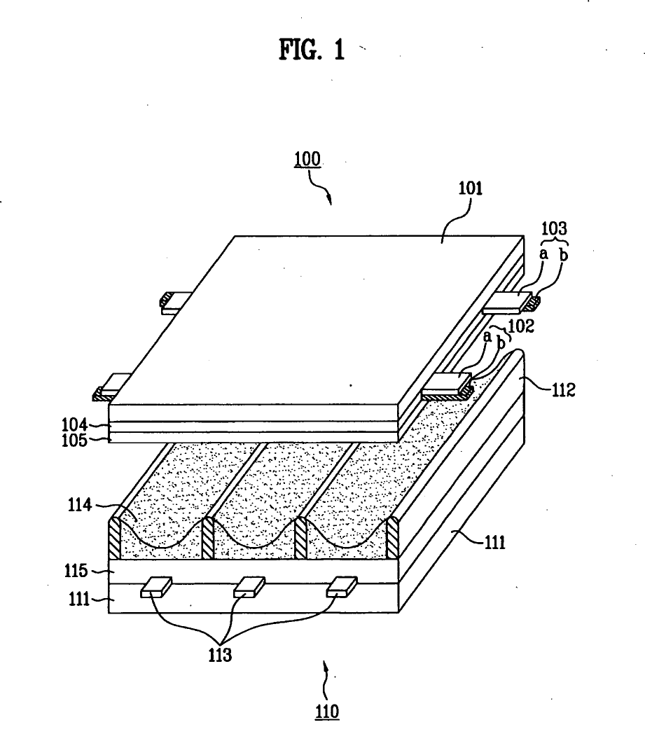

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

A plasma display panel according to the present invention has a feature in that electrodes thereof are formed by an offset process or ink-jet process. Specifically, with the offset process or ink-jet process, address electrodes may be formed on a lower panel of the plasma display panel, and bus electrodes may be formed on an upper panel of the plasma display panel.

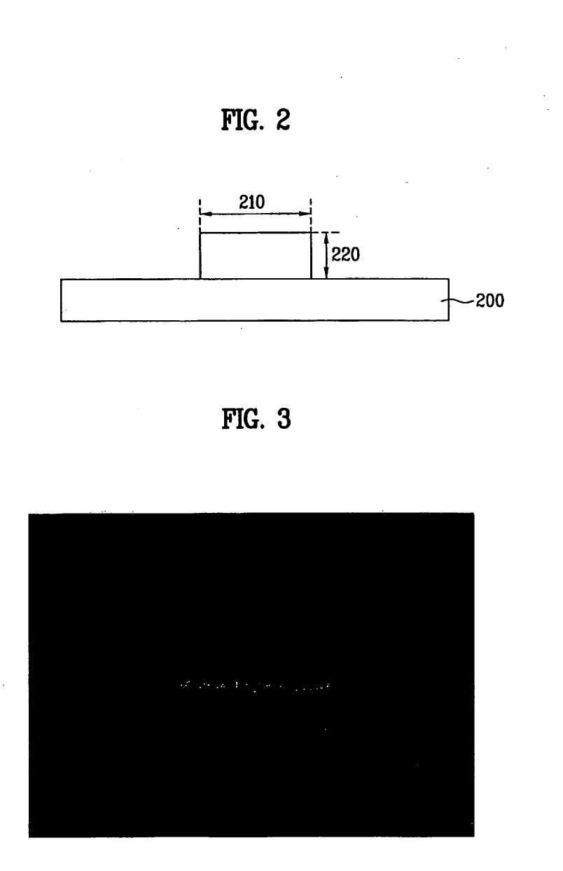

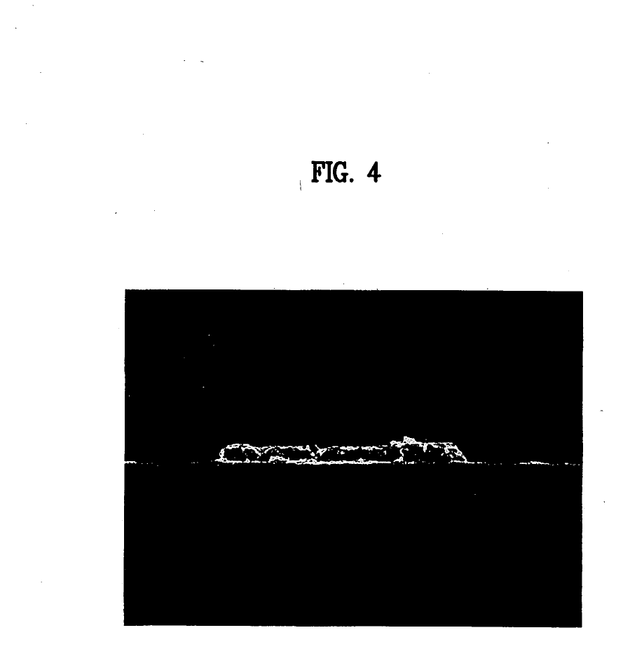

FIG. 2 is a schematic view illustrating an electrode of a plasma display panel according to a first embodiment of the present invention. FIG. 3 is a view illustrating the lifting of a conventional electrode formed by an ink-jet process or off-set process. FIG. 4 is a sectional view illustrating the electrode of the plasma display panel according to the first embodiment of the present invention. Now, the first embodiment of the plasma display panel according to the present invention will be explained with reference to FIGS. 2 to 4.

Referring to FIG. 2 schematically illustrating the electrode of the plasma display panel according to the first embodiment of the present invention, the electrode is formed on a substrate 200 in such a manner that a ratio of width 210 to thickness 220 thereof is preferably in a range of 5:1˜50:1, and more preferably, the width 210 of the electrode is in a range of 50˜100 μA.

If the ratio of width to thickness of the electrode formed by an ink-jet process or offset process is greater than 50:1, the electrode may exhibit the lifting at opposite ends thereof after being fired, and thus, suffer from an irregular shape as shown in FIG. 3.

Conversely, if the ratio of width to thickness of the electrode formed by an ink-jet process or offset process is smaller than 5:1, only a small amount of electrode paste or ink is injected or transcribed onto the substrate through nozzles of an ink-jet device or a blanket of an offset device. Accordingly, this results in a limit in the number of electrodes to be formed on the substrate, and makes it impossible to obtain a superior electrode pattern because of an irregular surface.

To solve the above described problems, it is desirable that the electrode formed by an ink-jet process or offset process have a ratio of width to thickness in a range of 5:1˜50:1. In this case, as shown in FIG. 4, the resulting electrode can achieve a regular cross section.

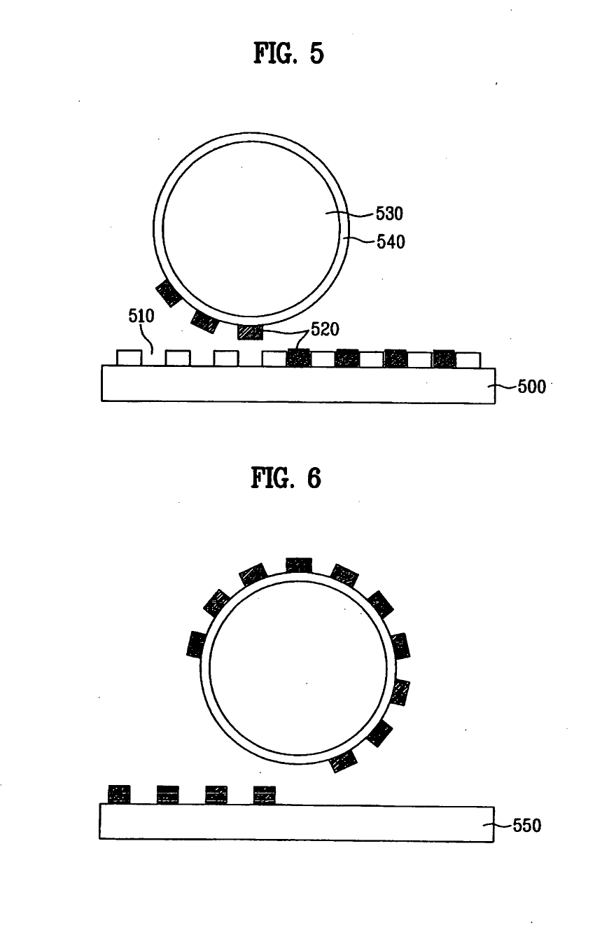

FIGS. 5 and 6 are schematic views illustrating a first embodiment of a method for forming electrodes of the plasma display panel according to the present invention. Now, the first embodiment of the electrode forming method according to the present invention will be explained with reference to FIGS. 5 and 6.

The present embodiment describes a method for forming electrodes of a plasma display panel by an offset process. First, a master mold 500 having recesses 510 is prepared. The recesses 510 are used for the injection of an electrode paste, and preferably, have a ratio of width to thickness in a range of 5:1˜50:1. More preferably, the recesses 510 have a width in a range of 50˜100 μm.

Subsequently, an electrode paste 520 is injected into the recesses 510. Preferably, the electrode paste 520 contains silver, binder, solvent, dispersing agent, etc. After the electrode paste 520 is injected into the recesses 510 of the master mold 500, the electrode paste 520 is finished in shape by means of a blade, to have the same shape as that of a desired electrode.

Thereafter, as shown in FIG. 5, a roll 530, around which a blanket 540 is wound, is rolled on the master mold 500, such that the electrode paste 520 injected in the recesses 510 is transferred onto a surface of the blanket 540.

Then, as shown in FIG. 6, the blanket 540 is rolled on a substrate 550, to transcribe the electrode paste 520 onto the substrate 550. Finally, if the electrode paste 520 is fired, the formation of electrodes is completed.

With the above described embodiment, the electrodes are formed by the offset process to have a ratio of width to thickness in a range of 5:1˜50:1, and thus, have a regular surface without causing the lifting of opposite ends of the electrode.

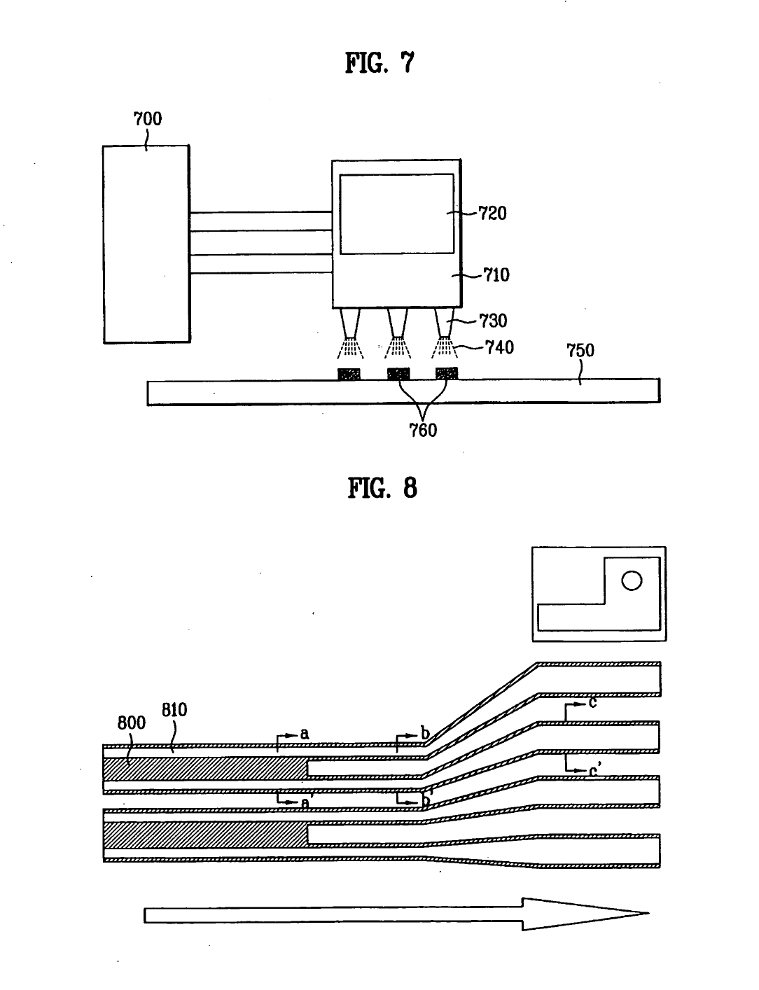

FIG. 7 is a view illustrating a second embodiment of the method for forming electrodes of the plasma display panel according to the present invention. Now, the second embodiment of the electrode forming method according to the present invention will be explained with reference to FIG. 7.

The present embodiment describes a method for forming electrodes by an ink-jet process. The ink-jet process is a method performed by injecting a compressed electrode material, such as ink containing silver, binder, solvent, and dispersing agent, from nozzles, to form an electrode pattern. This is an economic method performed in a very simplified procedure and not causing waste of material.

The ink-jet device used in the present embodiment includes a controller 700, head 710, ink reservoir 720 and nozzles 730. In operation, if the controller 710 transmits a signal for controlling an injection position and injection amount of the ink to the head 720, the head 710 injects the ink received in the ink reservoir 720 onto a substrate 750 of the plasma display panel through the nozzles 730 in response to the control signal, to form electrodes 760.

In this case, preferably, the control signal transmitted from the controller 710 is set up such that the electrode has a ratio of width to thickness in a range of 5:1˜50:1 and a width in a range of 50˜100 μm, similar to the above described first embodiment. Finally, if the ink injected onto the substrate 750 is dried and fired, the formation of the electrodes 760 is completed.

With the above described embodiment, the electrodes are formed by the ink-jet process to have a ratio of width to thickness in a range of 5:1˜50:1, and thus, have a regular surface without the lifting of opposite ends of the electrode.

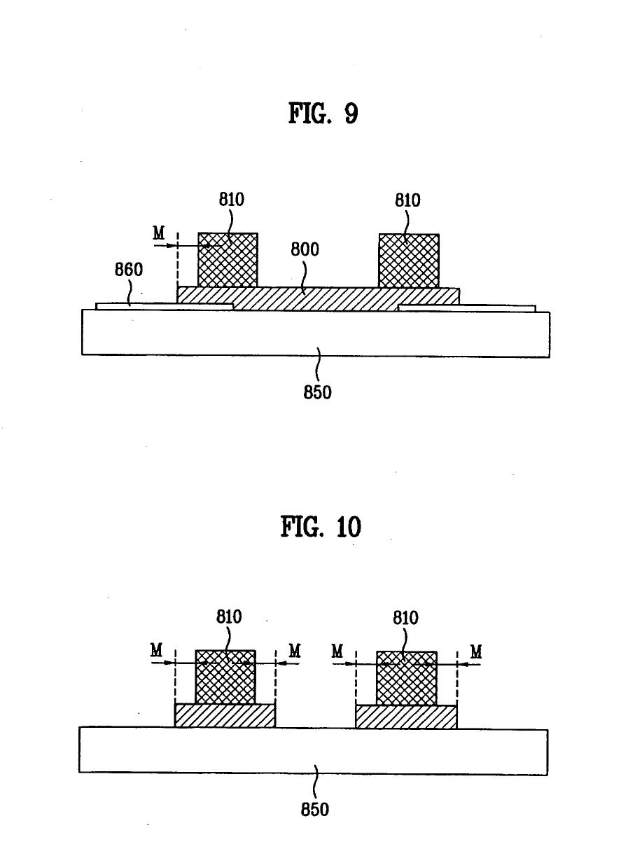

FIG. 8 is a plan view illustrating the electrode of the plasma display panel according to the second embodiment of the present invention. FIGS. 9 to 12 are sectional views illustrating the electrode of the plasma display panel according to the second embodiment of the present invention. Now, the electrode of the plasma display panel according to the second embodiment of the present invention will be explained with reference to FIGS. 8 to 12.

The plasma display panel according to the present embodiment has a feature in that transparent electrodes, a black electrode, and a bus electrode are formed on an upper panel in sequence to constitute each sustain electrode pair, and the black electrode has a width greater than that of the bus electrode within a pad portion because it is difficult to coincide outer lines of the black electrode and bus electrode with each other during formation thereof. When the electrodes are formed by an offset process, the above described inconformity in electrode lines especially becomes worsen.

In the plasma display panel according to the present invention, the upper panel has a feature in that sustain electrode pairs are formed on an upper glass plate 850, and each sustain electrode pair includes a pair of transparent electrodes 860, a black electrode 800, and a bus electrode 810. As shown in FIG. 9, the plasma display panel of the present invention has a feature in that the black electrode 800 is wider than the bus electrodes 810 by a predetermined distance M at each side of the bus electrode 810. Preferably, the predetermined distance M is in a range of 1˜100 μm. As described above, it is difficult to coincide outer lines of the black and bus electrodes in an offset process, and therefore, it is desirable that the width of the black electrode 800 located below the bus electrode 810 be greater than that of the bus electrode 810 to facilitate the conformity of electrode lines.

In FIG. 8, a portion including the line a-a′ indicates an effective display portion for displaying images, a portion including the line b-b′ indicates a non-effective display portion, and a portion including the line c-c′ indicates a pad portion connecting the panel to a circuit substrate of a module. Here, the effective display portion and non-effective display portion create an electric discharge region. As can be seen from FIG. 8, a width of the electrode pattern gradually increases from the electric discharge region to the pad portion. It can be expected that the smaller the predetermined distance M, the more difficult it is to coincide the bus electrode 810 with the black electrode 800, and the greater the predetermined distance M, the easier it is to coincide the bus electrode 810 with the black electrode 800. However, an excessive increase in the predetermined distance M has the possibility of a short circuit in neighboring electrodes. Accordingly, the predetermined distance M must be greater than at least 1 μm and smaller than 100 μm, to prevent a short circuit in neighboring electrodes. In the present embodiment, under the assumption that a distance between neighboring bus electrodes 810 is 200 μm, the predetermined distance M is determined to be a half of the maximum value 200 μm, i.e. 100 μm. Of course, if the arrangement of electrodes is different, the predetermined distance M must be correspondingly changed.

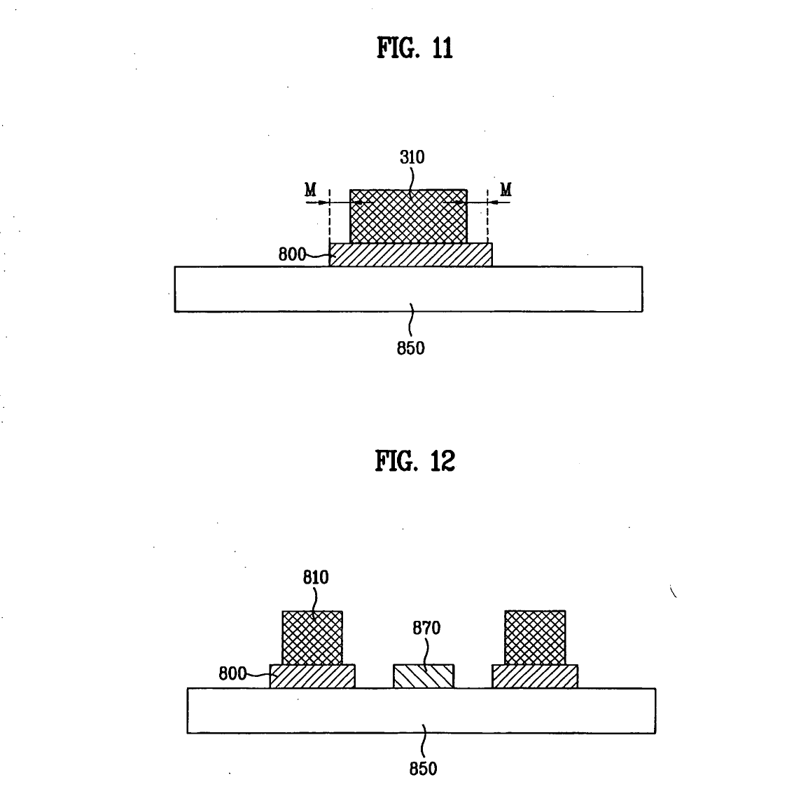

FIG. 9 is a sectional view taken along the line a-a′ of FIG. 8. As shown, in the effective display portion of the panel, the width of the black electrode 800 is greater than that of the bus electrodes 810 by the predetermined distance M at each side of the bus electrode 810. Also, FIGS. 10 and 11 are sectional views taken along the lines b-b′ and c-c′ of FIG. 8, respectively. As shown, even in the non-effective display portion and the pad portion of the panel, the width of the black electrode 800 is greater than that of the bus electrode 810 by the predetermined distance M at each side of the bus electrode 810. Also, FIG. 9 illustrates the effective display portion and thus, the transparent electrodes 860 formed on the substrate 850 are shown, but FIG. 10 illustrates the non-effective display portion and thus, no transparent electrodes are shown. Also, referring to FIG. 11 illustrating the pad portion, although the black electrode 800 and bus electrode 810 have widths greater than those of the effective display portion and non-effective display portion, the predetermined distance M is still maintained. The predetermined distance M is essential to accurately align the bus electrode on the black electrode because the bus electrode can fulfill its function when being formed on the black electrode.

As shown in FIG. 9, in the effective display portion of the panel according to the above described embodiment, the black electrode 800 is connected to the transparent electrodes 860 on the substrate 850. However, as shown in FIG. 12, the black electrode 800 may be divided so that the divided portions of the black electrode 800 are located on the respective transparent electrodes 860 to form sustain electrodes. In this case, preferably, a black matrix 870 is provided between neighboring sustain electrodes. The black matrix 870 is made of the same composition as that of the black electrode 860, and serves to absorb an external light being introduced into the plasma display panel, thereby preventing the external light from being reflected from a surface of the panel.

Hereinafter, a third embodiment of the method for forming electrodes of the plasma display panel according to the present invention will be explained. The method is related to the above described second embodiment of the plasma display panel according to the present invention.

First, black electrodes are formed on a substrate by an offset process using a first master mold. A process for forming the black electrode on the substrate using the first master mold will be explained as follows.

The first master mold having first recesses is manufactured. The first recesses are used to form black electrodes, and therefore, preferably have the same width as that of desired black electrodes. Next, a first electrode paste for forming the black electrodes is injected into the first recesses. Then, a blanket is rolled on the first master mold such that the first electrode paste is transferred onto the blanket. Subsequently, the blanket is rolled on the substrate, to transcribe the first electrode paste transferred thereon onto the substrate. Finally, if the electrode paste is fired, the formation of the black electrodes is completed. The firing process may be performed after transcription of the bus electrodes that will be explained hereinafter.

Subsequently, bus electrodes are formed on the black electrodes by use of a second master mold. A process for forming the bus electrodes using the second master mold is basically the same as that of the black electrodes using the first master mold. However, second recesses formed in the second master mold must have a width smaller than that of the first recesses, and preferably, must have a width difference of 1˜100 μm at each side thereof. It will be clearly understood that a second electrode paste to be injected into the second recesses for forming the bus electrodes has a different composition from that of the first electrode paste.

In a process for transcribing the above described bus electrodes, since the black electrode is wider than that of the bus electrodes by a predetermined distance at each side of the bus electrode, the bus electrodes can be easily aligned on the black electrodes when the blanket, on which the second electrode paste is bonded, is rolled. With the conformity of the black electrode and bus electrode, the efficiency of electric discharge can be increased.

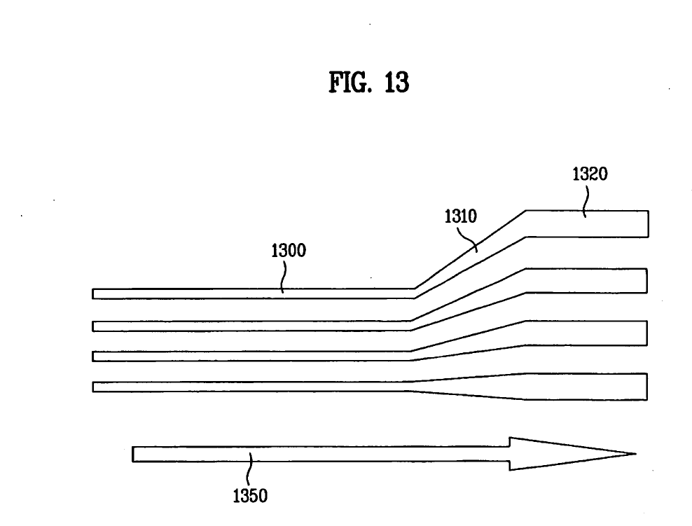

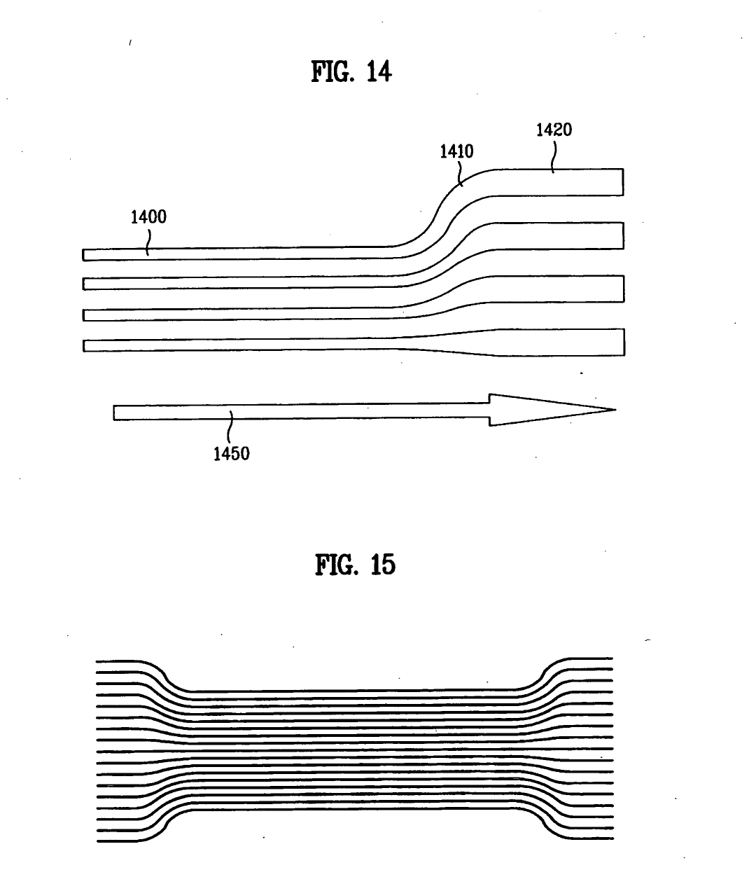

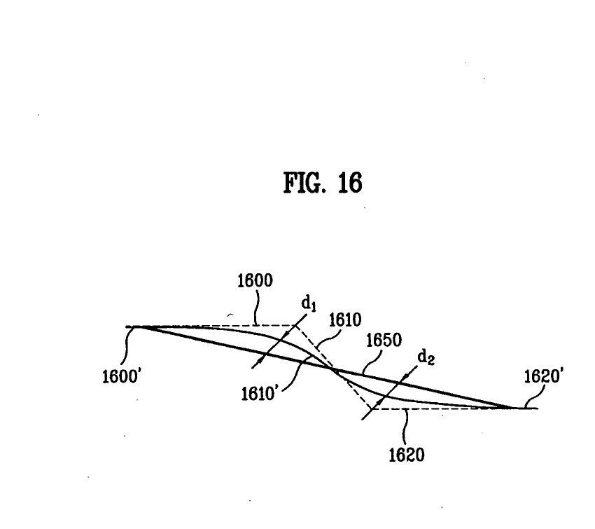

FIG. 13 is a view illustrating an electrode pattern of a plasma display panel formed by a conventional electrode forming method. FIG. 14 is a view illustrating an electrode pattern of a plasma display panel formed by an electrode forming method according to a third embodiment of the present invention. FIG. 15 is a schematic view of the electrode pattern of the plasma display panel according to the third embodiment of the present invention. FIG. 16 is a view comparing the electrode pattern of the plasma display panel according to the third embodiment of the present invention with the prior art. Now, the electrode pattern of the plasma display panel according to the third embodiment of the present invention will be explained with reference to FIGS. 13 to 16.

The present embodiment has a feature in that an electrode pattern has a curved electrode line in a connecting portion. Herein, the connecting portion is represented as the non-effective display portion in the above described second embodiment, and the electrode line of the connecting portion serves to connect an electrode line formed in the effective display portion to an electrode line formed in the pad portion. In the prior art as shown in FIG. 13, when an electrode line is applied to the panel in an offset process, an advance direction of the electrode line is suddenly bent in a connecting portion 1310 between an effective display portion 1300 and a pad portion 1320. The present invention provides an embodiment to solve the irregularity of the electrode line.

In FIG. 14 illustrating the third embodiment of the present invention, an electrode line 1400 formed in an effective display portion defines an image display region. Specifically, in the image display region, if so-called opposed discharge occurs between an address electrode and a scan electrode and so-called flat discharge occurs between the scan electrode and a sustain electrode, phosphors are excited by ultraviolet rays emitted from discharge cells to emit visible rays to the outside, thereby enabling the display of images. An electrode line 1420 formed in a pad portion is a region where electrodes of the panel are bonded to a flexible printed circuit board (FPC) of a module, and an electrode line thereof is wider than an electrode line 1400 of the effective display portion. An electrode line 1410 of a connecting portion is a region connecting the electrode line 1400 of the effective display portion to the electrode line 1420 of the pad portion, and a width of the electrode line thereof gradually increases toward the pad portion.

In the present embodiment, as shown in FIG. 16, the electrode pattern is spaced apart from a conventional electrode pattern, which is shown by a dotted line, by a predetermined distance, and forms a curved line as shown by a solid line. Specifically, the electrode pattern of the present embodiment is spaced apart from an imaginary straight line 1650, which connects a distal end 1620′ of the electrode line formed in the effective display portion to a distal end 1600′ of the electrode line formed in the pad portion, by predetermined distances d₁ and d₂. Preferably, the predetermined distances d₁ and d₂ are in a range of 1˜50 μm. If the predetermined distances d₁ and d₂ are smaller than 1 μm, the electrode pattern has no difference from the conventional straight electrode pattern. Also, if the predetermined distances d₁ and d₂ are greater than 50 μm, it may cause a short circuit in neighboring electrodes.

FIG. 15 schematically illustrates the above described electrode line pattern. As shown, the electrode pattern is configured in such a manner that the electrode line of the connecting portion, which connects the electrode line formed in the effective display portion with the electrode line formed in the pad portion, has a curved shape. A distance between the electrode line of the connecting portion and the above described imaginary straight line 1650 is larger at the outer periphery of the panel than at the center of the panel.

Accordingly, in the present invention, the electrode line of the connecting portion is formed evenly, and thus, there is no lifting of opposite ends of the electrode after completion of a firing process. This is efficient to prevent an increase in the resistance of electrodes, which is caused by the concentration of electric field occurring in a bent portion of the conventional electrode pattern.

Hereinafter, a fourth embodiment of the method for forming the electrodes of the plasma display panel according to the present invention will be explained. The method is related to not described another embodiment of the plasma display panel according to the present invention.

First, a master mold to be used in an offset process is manufactured. The master mold is formed with recesses where an electrode paste for forming electrodes will be injected. Preferably, the recesses are arranged along a curved path in a portion corresponding to the electrode line of the connecting portion that connects the electrode line formed in the effective display portion to the electrode line formed in the pad portion. In this case, the resulting curved electrode pattern is preferably spaced apart from the above described imaginary straight line, which connects the distal end of the electrode line formed in the effective display portion to the distal end of the electrode line formed in the pad portion, by a distance in a range of 1˜50 μm. After completing the formation of the recesses, the electrode paste is injected into the recesses. The electrode paste for forming the electrodes preferably contains silver, binder, solvent, dispersing agent, etc. Thereafter, the electrode paste injected in the recesses of the master mold is finished in shape by means of a blade, to have the same shape as that of desired electrodes.

Then, the blanket is rolled on the master mold, to transfer the electrode paste injected in the recesses to the surface of the blanket. Subsequently, the blanket, to which the electrode paste is bonded, is rolled on the substrate, to transfer the electrode paste onto the substrate. In this case, the electrode line of the connecting portion that connects the electrode line formed in the effective display portion to the electrode line formed in the pad portion forms a curved line. The curvature of the curved electrode line in the connecting portion, etc. is the same as the above description.

With the above described method, the electrode pattern of the plasma display panel can be easily formed using an offset process, and this has the effect of simplifying an electrode forming process and reducing material costs.

In the above described embodiments of the plasma display panel and method for forming the electrodes thereof, other constituent elements except for the electrodes and method for forming the same are the same as those of the prior art.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A plasma display panel comprising upper and lower panels bonded to face each other with barrier ribs therebetween, wherein
at least one of electrodes formed on the upper and lower panels has a ratio of width to thickness in a range of 5:1˜50:1.

2. The panel according to claim 1, wherein the electrodes are formed by an offset process or ink-jet process.

3. The panel according to claim 1, wherein the electrodes have a width in a range of 50˜100 μm.

4. A method for forming electrodes of a plasma display panel comprising:
preparing a master mold that is formed with recesses having a ratio of width to thickness in a range of 5:1˜50:1;
injecting an electrode paste into the recesses formed in the master mold;
transferring the electrode paste, injected in the recesses, onto a blanket; and
transcribing the electrode paste, transferred to the blanket, onto a substrate.

5. The method according to claim 4, wherein the recesses have a width in a range of 50˜100 μm.

6. The method according to claim 4, wherein the electrode paste contains silver, binder, solvent, and dispersing agent.

7. A method for forming electrodes of a plasma display panel comprising:
transmitting a signal for controlling an injection position and injection amount of ink from a controller; and
regulating the position and amount of ink to be injected from nozzles based on the control signal, to form electrodes having a ratio of width to thickness in a range of 5:1˜50:1.

8. The method according to claim 7, wherein the electrodes have a width in a range of 50˜100 μm.

9. The method according to claim 7, wherein the ink contains silver, binder, solvent, and dispersing agent.

10. A plasma display panel comprising upper and lower panels bonded to face each other with barrier ribs therebetween,
wherein the upper panel is formed with sustain electrode pairs each including transparent electrodes, a black electrode and a bus electrode, and
wherein, in a pad portion of the panel, a width of the black electrode is greater than a width of the bus electrode.

11. The panel according to claim 10, wherein, in the pad portion, the width of the black electrode is greater than that of the bus electrode by a difference of 1˜100 μm at each side of the bus electrode.

12. The panel according to claim 10, wherein, in an effective display portion of the panel, the width of the black electrode is greater than that of the bus electrode.

13. The panel according to claim 12, wherein, in the effective display portion, the width of the black electrode is greater than that of the bus electrode by a difference of 1˜100 μm at each side of the bus electrode.

14. The panel according to claim 10, further comprising:
a black matrix formed in the effective display portion between neighboring sustain electrode pairs.

15. A method for forming electrodes of a plasma display panel comprising:
forming black electrodes via an offset process using a first master mold: and
forming bus electrodes via an offset process using a second master mold.

16. The method according to claim 15, wherein the black electrodes have a width greater than a width of the bus electrodes.

17. The method according to claim 16, wherein the width of the black electrode is greater than that of the bus electrode by a difference of 1˜100 μm at each side of the bus electrode.

18. The method according to claim 15, wherein the formation of the black electrodes comprises:
preparing the first master mold formed with first recesses;
injecting a first electrode paste into the first recesses;
transferring the first electrode paste, injected in the first recesses, to a blanket; and
transcribing the first electrode paste, transferred on the blanket, onto a substrate.

19. The method according to claim 15, wherein the formation of the bus electrodes comprises:
preparing the second master mold formed with second recesses;
injecting a second electrode paste into the second recesses;
transferring the second electrode paste, injected in the second recesses, to a blanket; and
transcribing the second electrode paste, transferred on the blanket, onto a substrate.

20. A plasma display panel comprising upper and lower panels bonded to face each other with barrier ribs therebetween, wherein
an electrode line of a connecting portion that connects an effective display portion and a pad portion is curved.

21. The panel according to claim 20, wherein the electrode line of the connecting portion is spaced apart from a straight line, which connects a distal end of an electrode line formed in the effective display portion and a distal end of an electrode line formed in the pad portion, by a predetermined distance.

22. The panel according to claim 21, wherein the predetermined distance is in a range of 1˜50 μm.

23. The panel according to claim 21, wherein the predetermined distance increases from the electrode line of the connecting portion located at the center of the panel to the electrode line of the connecting portion located at the outer periphery of the panel.

24. A method for forming electrodes of a plasma display panel by an offset process comprising:
transferring an electrode paste onto a blanket: and
transcribing the electrode paste, transferred on the blanket, onto a substrate, to form a curved electrode line in a connecting portion of the panel.

25. The method according to claim 24, wherein the transcription of the electrode paste comprises:
rolling the blanket along a straight path in an effective display portion and pad portion of the panel while rolling the blanket along a curved path in the connecting portion of the panel.

26. The method according to claim 25, wherein the curved electrode line is spaced apart from a straight line, which connects a distal end of an electrode line formed in the effective display portion and a distal end of an electrode line formed in the pad portion, by a distance in a range of 1˜50 μm.

27. The method according to claim 24, wherein the electrode paste contains silver, binder, solvent and dispersing agent.
